(19) United States
(12) Patent Application Publication
(10) Pub. No.: US 2008/0022832 A1
(43) Pub. Date: Jan. 31, 2008

(54) SAW BLADE FOR CUTTING CEMENT BOARD

(75) Inventor: John Curtsinger, Shelbyville, KY (US)

Correspondence Address: HARNESS, DICKEY & PIERCE, P.L.C., P.O. BOX 828, BLOOMFIELD HILLS, MI, 48303, US

(73) Assignee: BLACK & DECKER INC., Newark, DE (US)

(21) Appl. No.: 11/460,454

(22) Filed: Jul. 27, 2006

(51) Int. Cl. B23D 57/00

(52) U.S. Cl. 83/835

(57) ABSTRACT

According to the present disclosure, a saw blade includes a plurality of edge portions and a plurality of cutting portions. The edge portions each include a gullet. The gullet extends constantly radially outwardly from a central portion of the edge portions to the cutting portion.

### FIELD

The present disclosure relates to saw blades, and more specifically to circular saw blades for cutting cement board.

### BACKGROUND AND SUMMARY

The statements in this section merely provide background information related to the present disclosure and may not constitute prior art.

Circular saw blades for cutting materials such as cement board often include a cutting portion having a thickness generally less than or equal to a thickness of the saw blade body and a radially inwardly extending gullet at the leading edge of a cutting portion. While this gullet may provide a clearance for materials being removed, it may often provide for material build-up therein.

According to the present disclosure, a saw blade includes a plurality of edge portions and a plurality of cutting portions. The edge portions each include a gullet. The gullet extends constantly radially outwardly from a central portion of the edge portions to the cutting portion.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a saw blade according to the present teachings;

FIG. 2 is a front plan view of the saw blade of FIG. 1;

FIG. 3 is a bottom plan view of the saw blade of FIG. 1; and

FIG. 4 is a fragmentary front plan view of a cutting portion of the saw blade of FIG. 1.

### DETAILED DESCRIPTION

The following description is merely exemplary in nature and is not intended to limit the present disclosure, application, or uses.

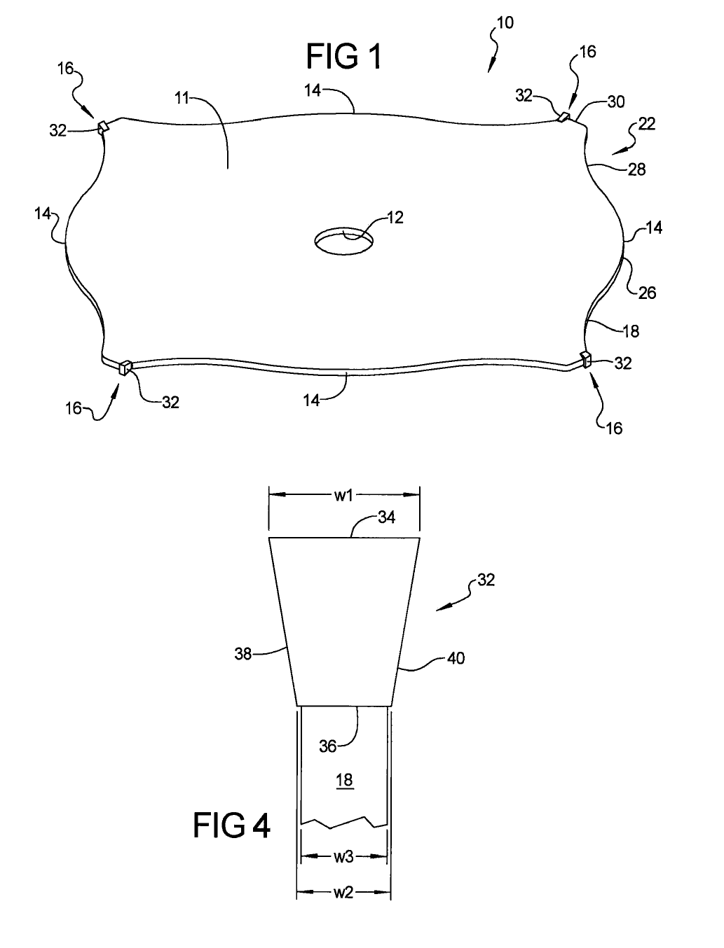

With reference to FIGS. 1-4, a circular saw blade 10 may include a plate 11 including a mounting aperture 12 through a central portion thereof and a series of edge portions 14 and cutting portions 16 defining an outer periphery thereof. Cutting portions 16 may be disposed between edge portions 14. In the present example, four cutting portions 16 are shown disposed between four edge portions 14. Edge portions 14 each include a gullet 18 disposed adjacent to a forward side of cutting portions 16 at a first end of the edge portions 14. A shoulder 22 is disposed on a rearward side of the cutting portions 16 at a second end of edge portions 14. Although four edge portions 14 and cutting portions 16 are shown, it should be understood that between 3 and 12 cutting portions 16 and edge portions 14 may be included.

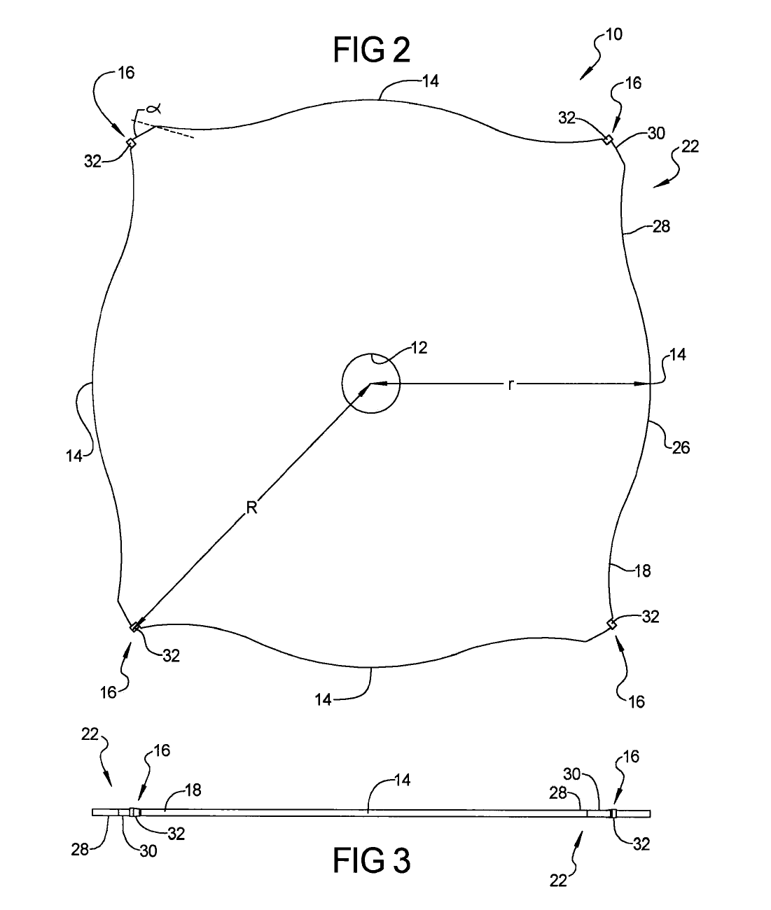

With reference to FIG. 2, edge portions 14 may generally form central circular perimeter portions 26 of saw blade 1 0. Central circular perimeter portions 26 may have a radius (r) of between 70.0 and 80.0 mm.

Cutting portions 16 may extend radially outwardly from the central circular permiter portions 26 of edge portions 14. Cutting portions 16 may have a radially outward extent from the center of rotation of radius (R), which may be generally greater than radius (r). More specifically, cutting portions 16 may extend radially outwardly from central circular perimeter portions 26 by a distance (R−r) of between 5 and 10 percent of radius (r) of central circular perimeter portions 26.

Gullet 18 may extend constantly radially outwardly from an end of the central circular perimeter portion 26. More specifically, gullet 18 may have an arcuate shape, constantly increasingly in radially outward extent from central circular perimeter portion 26 to cutting portion 16. Gullet 18 may have a radius of curvature of between 45 and 55 mm. Gullet 18 does not extend radially inwardly relative to central circular perimeter portion 26 toward aperture 12, thereby preventing chips from building up therein.

Shoulder 22 may extend constantly radially outwardly from a second end of the central circular perimeter portion 26. Shoulder 22 may include first and second portions 28, 30. First portion 28 may be generally similar to gullet 18. First portion 28 may have an arcuate shape, extending constantly increasingly in radially outward extent from central circular perimeter portion 26 to second portion 30. First portion 28 may have a radius of curvature of between 45 and 55 mm. First portion 28 may therefore not extend radially inwardly relative to central circular perimeter portion 26 toward aperture 12. Second portion 30 may extend between and connect first portion 28 and cutting portion 16. Second portion 30 may be generally linear and extend at an angle extending radially outwardly from first portion 28. The second portion 30 of shoulder 22 extends at an angle a of between 70 and 80 degrees from a tangent to the intersection of first portion 28 and second portion 30.

Cutting portion 16 may include a tip insert 32. With reference to FIG. 4, tip insert 32 may include a radially outer edge 34, a radially inner edge 36, and side edges 38, 40. Radially outer edge 34 may have a first width w1 and radially inner edge 36 may have a second width w2 generally less than first width w1. As such, side edges 38, 40 may generally taper inwardly from radially outer edge 34 to radially inner edge 36. Both first and second widths w1, w2 may be greater than the width w3 of saw blade edge portions 14. In the present example, first width w1 may be between 2.0 and 2.5 mm, second width w2 may be between 1.7 and 1.8 mm, and third width w3 may be between 1.5 and 1.65 mm. Tip insert 32 is disclosed as the preferred cutting portion 16, although it should be understood that the cutting portion 16 can take the form of an integrally formed cutting edge.

What is claimed is:

1. A saw blade comprising:
a plate including a plurality of edge portions;
a plurality of cutting portions disposed between said plurality of edge portions; and
said plurality of edge portions including a central portion and a gullet disposed between and connecting said central portion and one of said cutting portions, said gullet extending constantly radially outwardly from said central portion to said cutting portion.

2. The saw blade of claim 1, wherein said plurality of edge portions further include a shoulder portion extending constantly outwardly from said central portion and connecting said central portion and one of said cutting portions, said cutting portion disposed between said shoulder portion of one of said plurality of edge portions and said gullet of an adjacent one of said plurality of edge portions.

3. The saw blade of claim 1, wherein said gullet includes a generally arcuate shape.

4. The saw blade of claim 3, wherein said gullet includes a radius of curvature greater than 45 mm.

5. The saw blade of claim 4, wherein said central portions of said plurality of edge portions include a generally circular perimeter, said generally circular perimeter having a radius of between 70 and 80 mm.

6. The saw blade of claim 1, wherein the plurality of cutting portions includes between 3 and 12 cutting portions disposed around a periphery thereof.

7. The saw blade of claim 6, wherein said cutting portions are spaced generally equidistant from one another.

8. The saw blade of claim 1, wherein said cutting portions include a tip, said tip having a width generally greater than a width of said edge portions.

9. The saw blade of claim 8, wherein said tip is in the form of an insert.

10. The saw blade of claim 8, wherein said tip includes a first width at a radially outer edge and a second width at a radially inner edge, said first width being greater than said second width.

11. The saw blade of claim 10, wherein said first and second widths are both greater than a width of said edge portions.

12. A saw blade comprising:
a plurality of cutting portions;
a plurality of edge portions disposed between said plurality of cutting portions; and
said edge portions each including a central portion and a gullet extending between and connecting a first end of said central portion and one of said cutting portions, said gullet extending constantly radially outward from said first end of said central portion to said first cutting portions, said edge portions further including a shoulder portion extending between and connecting a second end of said central portion and a second of said cutting portions.

13. The saw blade of claim 12, wherein said shoulder portion extends constantly radially outwardly from said second end of said central portion.

14. The saw blade of claim 12, wherein said gullet includes a generally arcuate shape.

15. The saw blade of claim 12, wherein said gullet includes a radius of curvature greater than 45 mm.

16. The saw blade of claim 15, wherein said central portions of said edge portions include a generally circular perimeter having a radius of between 70 and 80 mm.

17. The saw blade of claim 12, wherein said cutting portions include a tip, said tips having a width generally greater than a width of said edge portion.

18. The saw blade of claim 17, wherein said tips are in the form of an insert.

19. The saw blade of claim 17, wherein said tips include a first width at a radially outer edge and a second width at a radially inner edge, said first width being greater than said second width.

20. The saw blade of claim 19, wherein said first and second widths are both greater than a width of said edge portions.
